(19) United States
(12) Patent Application Publication
(10) Pub. No.: US 2024/0326934 A1
(43) Pub. Date: Oct. 3, 2024

(54) IDLER FOR TRACKED MACHINES

(71) Applicant: Caterpillar Inc., Peoria, IL (US)

(72) Inventor: Brian B. Umbach, Peoria, IL (US)

(73) Assignee: Caterpillar Inc., Peoria, IL (US)

(21) Appl. No.: 18/128,815

(22) Filed: Mar. 30, 2023

(51) Int. Cl. B62D 55/14; B62D 55/06; B62D 55/20; E02F 3/30

(52) U.S. Cl. CPC B62D 55/14; B62D 55/06; B62D 55/202; E02F 3/308

(57) ABSTRACT

An idler for a tracked machine may include a unitary hub and a substantially unitary disk-shaped web centered on the hub and extending radially outward from the hub to an outer cylindrical edge. The idler may also include an outer rim arranged proximate the outer cylindrical edge and extending laterally relative to the disk-shaped web. The outer rim may include a raised portion flanked by a pair of lower ledges, the raised portion and the pair of lower ledges having a cross-sectional profile configured for engagement by a link assembly of a track system.

### TECHNICAL FIELD

The present application relates to track systems for work machines such as excavators, tracked drills, crawlers, and other work machines. More particularly, the present application relates to pulleys, sprockets, sheaves, idlers, or other wheel-like elements that guide the motion of and/or provide power to the track. Still more particularly, the present application relates to an idler design that is particularly efficient to manufacture.

### BACKGROUND

Motive tracks on tracked machines can involve a large number of moving parts to provide power to the track and guide the motion of track. Many of these parts may be quite robust parts to withstand the harsh environments encountered by the track. In some cases, the manufacturing process for the parts may be relatively involved in an effort to manage the weight of the parts while also providing for robust parts. The main guiding/powering elements of a track on a tracked machine may include a sprocket at one end or corner of a track path and one or more idlers at an opposing end or other end or corner of a track path. These elements may be experience large loads due to the tension in the very robust track and their role in maintaining the corner or end positions of the track. These loading conditions can exacerbate the difficulties of managing the weight of the part during the design and manufacturing process and the resulting manufacturing process for these robust elements may be cumbersome, involved, and/or expensive.

Chinese patent application 201610696225 relates to a modularized guiding wheel and manufacturing process thereof. The modularized guiding wheel comprises an outer wheel body, a connecting part and a wheel shaft installing part. The outer wheel body, the connecting part and the wheel shaft installing part are coaxially arranged from outside to inside; the outer wheel body and the wheel shaft installing part are connected through the connecting pat; at least one of the outer wheel body, the wheel shaft installing part and the connecting part is of an annular structure manufactured from plates or profiles; and the guiding wheel is formed by welding the annular structures.

### SUMMARY

In one or more examples, an idler for a tracked machine may include a a unitary hub and a substantially unitary disk-shaped web centered on the hub and extending radially outward from the hub to an outer cylindrical edge. The idler may also include an outer rim arranged proximate the outer cylindrical edge and extending laterally relative to the disk-shaped web. The outer rim may include a raised portion flanked by a pair of lower ledges, the raised portion and the pair of lower ledges having a cross-sectional profile configured for engagement by a link assembly of a track system.

In one or more examples, a method of manufacturing an idler may include obtaining a hub, obtaining a substantially unitary disk-shaped web and connecting the web to the hub. The method may also include forming an outer rim by forming a unitary outer rim having a raised portion and flanking lower ledges, welding the outer rim to the disk-shaped web, and installing gussets. Alternatively or additionally, forming an outer rim may include forming annular rings and welding the annular rings to opposing sides of the disk-shaped web to form the outer rim with a raised portion and flanking lower ledges.

### BRIEF DESCRIPTION OF THE DRAWINGS

FIG. 1 is a perspective view of a work machine having a track system including an idler, according to one or more examples.

FIG. 2 is a perspective view of the track system of FIG. 1, according to one or more examples.

FIG. 3A is a side view of the idler of FIGS. 1 and 2, according to one or examples.

FIG. 3B is a cross-sectional view thereof.

FIG. 3C is a perspective view thereof.

FIG. 4 is a cross-sectional view of an outer rim of an idler interfacing with a link assembly of a track, according to one or more examples.

FIG. 5A is a perspective view of another example of an idler suitable for use with the excavator and track system of FIGS. 1 and 2, according to one or more examples.

FIG. 5B is a cross-sectional view thereof.

FIG. 5C is a perspective view thereof and including an optional segmented ring, according to one or more examples.

FIG. 6A is a perspective view of another example of an idler suitable for use with the excavator and track system of FIGS. 1 and 2, according to one or more examples.

FIG. 6B is a cross-sectional view thereof.

FIG. 6C is a perspective view thereof and including an optional segmented ring, according to one or more examples.

FIG. 7 is a diagram depicting a method of manufacturing of the idlers of FIGS. 3A-SC.

### DETAILED DESCRIPTION

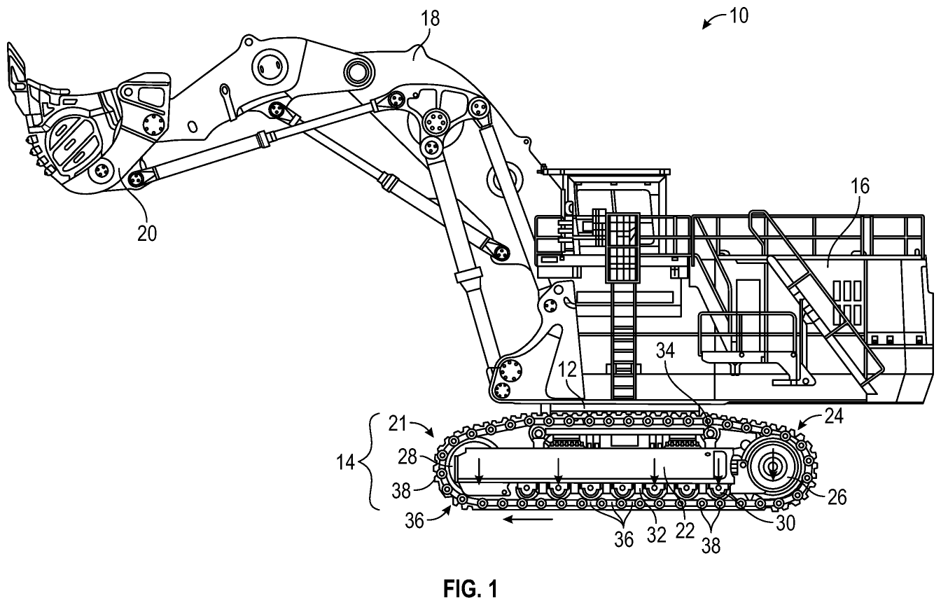

FIG. 1 is a schematic side view of work machine 10 comprising a chassis 12 and having an undercarriage system 14. The work machine 10 may be any type of work machine that includes a tracked undercarriage system. In the example shown in FIG. 1, the work machine 10 is an excavator comprising superstructure 16 pivotally supported on the chassis 12. As shown, the work machine 10 can include an implement 18 comprising one or more hydraulically operated arms, which may have an excavating bucket 20 attached thereto for digging. The work machine 10 may alternatively be another type of machine, including, but not limited to, a track-type tractor, a tracked drill, or another tracked machine.

The undercarriage 14 may be configured to support the work machine 10 relative to a supporting surface such as the ground and to provide for moving the work machine along the ground, roads, and/or other types of terrain. The undercarriage 14 may include a track system 21 with a track roller frame 22, various guiding components connected to the track roller frame 22, and an endless or continuously looping track 24 engaging the guiding components. The guiding components of undercarriage 14 may include a drive sprocket 26, an idler 28, rollers 30, a track guide 32 and a carrier 34.

The track 24 can comprise link assemblies 36 that can form a flexible backbone for the track 24. Link assemblies 36 can comprise a plurality of track shoes 38 joined by a plurality of links connected to one another at pivot joints. In FIG. 1, only half of links can be seen. For each link visible in FIG. 1, each link assembly 36 can include a corresponding laterally spaced link (located further into the plane of FIG. 1). Link assemblies 36 can extend in an endless chain around drive sprocket 26, rollers 30, idler 28, and carrier 34. Track shoes 38 can be located at the perimeter of link assemblies 36. For example, track 24 can include shoes 38 attached to, or integral with, the outside surface of each laterally spaced pair of links.

Rollers 30 and track guide 32 can guide the lower portion of track 24. Rollers 30 can each be suspended beneath track roller frame 22. For example, rollers 30 can be rotationally supported on axles coupled to track roller frame 22. The undersides of rollers 30 can ride on and guide links in the lower portion of the endless chain formed by link assemblies 36. Track guide 32 can also be suspended from track roller frame 22. Track guide 32 can extend along adjacent sides of links in the lower portion of the endless chain formed by the link assemblies 36, thereby further guiding this portion of link assemblies 36.

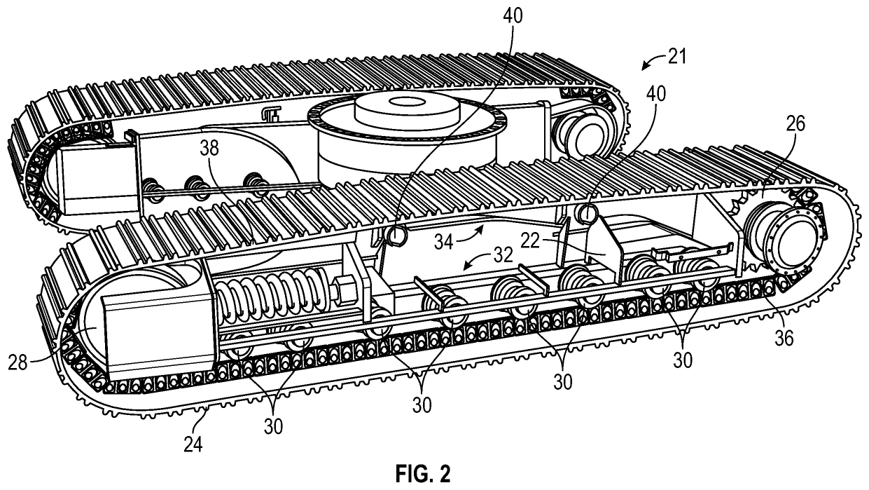

The carrier 34 can guide the upper portion of track 24, such as by extending upward from track roller frame 22 and engaging a portion of link assemblies 36 in an upper portion of its endless chain. The carrier 34 can have various configurations. As shown in FIG. 2, in the illustrated embodiment, carrier 34 can include rollers 40 on which link assemblies 36 ride.

The drive sprocket 26 and the idler 28 can guide the end portions of the loop of track 24. The drive sprocket 26 and idler 28 can be suspended from opposite ends of track roller frame 22. The ends of the loop formed by link assemblies 36 can wrap around the drive sprocket 26 and the idler 28. One or more portions of the drive sprocket 26 can project into spaces between laterally spaced pairs of links. In some cases, one or more portions of idler 28 may also project into spaces between laterally spaced pairs of links. The drive sprocket 26 and idler 28 can rotate about lateral axes to guide the ends of link assemblies 36 through approximately semicircular paths between the lower and upper portions of the endless chain formed by the link assemblies 36. In some cases, multiple idlers may be provided where the track follows a generally triangular path rather than an out and back path as shown. Still other track paths may be provided. Additionally, where the idler 28 or sprocket 26 extend into spaces between laterally spaced pairs of links, sprocket 26 and idler 28 can guide link assemblies 36 in lateral directions. Sprocket 26 can be rotated by an external power source (e.g., a prime mover within superstructure 16 not shown) to move one end of link assemblies 36 between the top and bottom stretches. Driven by sprocket 26, link assemblies 36 can, in turn, rotate idler 28 and rollers 30 around their rotation axes. The drive sprocket 26 can be located adjacent the ground at a height approximately the same as idler 28. Alternatively, in some embodiments, drive sprocket 26 may be elevated significantly above the ground at a height significantly higher than idler 28. For example, drive sprocket 26 may be positioned above track roller frame 22.

Track guide 32 and track guide 34 may help guide the end of track 24 adjacent idler 28. If track 24 should separate from rollers 30, track guide 34 can help guide track 24 back into proper engagement with rollers 30. Track guide 34 can extend down beside link assemblies 36 adjacent idler 28. Track guide 34 can extend from track roller frame 22 adjacent a side of links as they extend around idler 28. Thus, track guide 34 can help keep link assemblies 36 properly aligned laterally as they extend around idler 28.

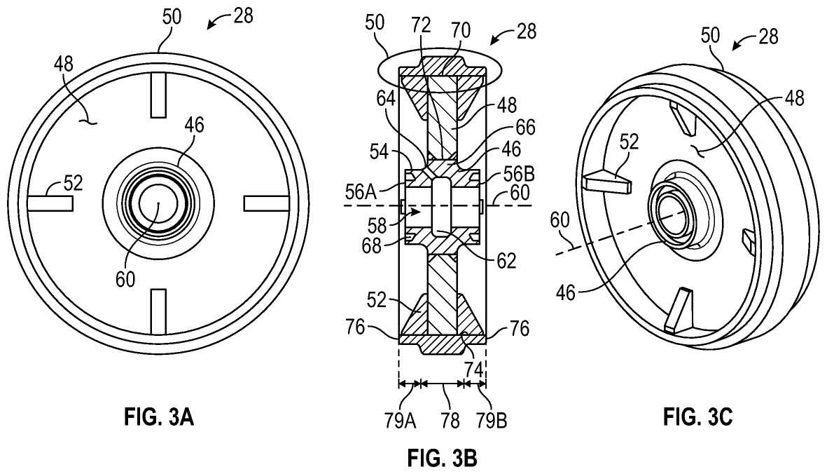

Referring now to FIG. 3A, one example of idler 28 is shown. The idler 28 may be configured to rotate freely about a laterally extending axis and guide the motion of the track and/or link assembly about an end, corner, or other transition of the track system. The idler may include a hub 46, a web 48, and an outer rim 50, and reinforcing gussets 52 may also be provided.

As shown in FIGS. 3A-3C, the hub 46 is arranged generally at a central portion of the idler 28. The hub 46 is configured for supporting the idler 28 relative to an axle and providing for rotation of the idler 28 relative to the axle. As shown, the hub 46 may include a generally cylindrical element having an outer cylindrical surface 54, opposing annular ends 56A/B and defining an axle bore 58 extending therethrough. The hub 46 may be arranged on its side and the axle bore 58 may have a central longitudinal axis 60 extending therethrough and defining the rotational axis of the hub 46 and the idler 28. The hub 46 may be a generally thick-walled component configured for receiving radial and bending forces from the web 48 and for transferring those forces to the axle via a bearing assembly (not shown). As shown, an inner wall of the axle bore 58 may include a lubrication recess 62 for receiving and/or storing lubrication for the bearing assembly arranged within the hub 46. The lubrication recess 62 may be an annularly shaped groove arranged generally centrally along the axle bore 58. A lubrication supply path 64 may be provided extending from the lubrication recess 62 through the wall of the hub 46 to an exterior and accessible location on the hub 46. A grease zerk or other fitting may be arranged on the outside of the hub 46 where the lubrication supply path 64 reaches the surface of the hub 46.

As shown, the hub 46 may include a peripheral rib 66 configured for interfacing with the web 48 of the idler 28. As shown, the peripheral rib may include an annular rib arranged generally centrally along the length of the hub 46 and extending radially outward from the outer cylindrical surface 54. The peripheral rib 66 may extend around and along the outer cylindrical surface 54 of the hub 46 providing a raised surface for attaching or securing the web 48. In one or more examples, the lubrication supply path 64 may extend from the lubrication recess 62 within the hub 46 to a location at or around the intersection of the peripheral rib 66 and the outer surface 54 of the cylindrical portion of the hub 46. As shown, the transition from the outer cylindrical surface 54 of the hub 46 to the peripheral rib 66 may include a radiused corner for control of forces passing through the rib 66 and into the main wall of the hub 46. The annular ends 56A/B of the hub 46 may include annular recesses 68 configured for receiving hub caps or other retaining elements for holding the bearing in place along the longitudinal axis of the axle bore 58 and/or for maintaining grease or other lubrication within the hub 46 and in and/or around the bearing assembly.

The hub 46 may be a substantially unitary structure. That is, for example, the cylindrical element with the cylindrical outer surface in addition to the peripheral rib may be a single unitary structure formed and shaped as a single piece or unit. To be clear, this may mean the hub is not a built up weldment, for example, but instead is a cast, forged, or machined element free of internal seams where multiple parts would otherwise come together.

The web 48 may be secured to the hub 46 and may be configured to connect the outer rim 50 to the hub 46. That is, the outer rim 50 may be arranged to encircle the hub 46 at a radial distance from the hub 46 and the web 48 may reach across the radial space between the hub 46 and the outer rim 50 to support the outer rim 50 relative to the hub 46 by resisting the radial and/or lateral forces experienced by the outer rim 50. As shown, the web 48 may include a disk-shaped web. That is, the web 48 may include a generally flat plate having an inner (e.g., relative to the work machine) annular surface and an outer (e.g., relative to the work machine) annular surface separated by a thickness. The web 48 may include a cylindrical outer edge 70 configured for interfacing with an outer rim 50 and an cylindrical inner edge 72 configured for interfacing with the hub 46. In one or more examples, the disk-shaped web may extend the full distance from the peripheral rib 66 on the hub 46 to the outer rim 50. Moreover, as shown, the disk-shaped web may be the only structure that connects the hub 46 to the outer rim 50. That is, multiple disks or additional webs might not be provided. Still further, and like the hub 46, the disk-shaped web may be a monolithic or unitary plate which is to say that it does not include multiple welded elements, but instead, is a single element sized, shaped, and formed to reach between the hub 46 and the outer rim 50. In some examples, the disk-shaped web may also be uninterrupted, which is to say that it may be free of openings extending laterally through the plate, for example. The web 48 may also be solid and free from internal openings or hollow portions, for example. As shown in FIG. 3B, the web may have an edge preparation on the cylindrical inner edge 72 to receive a groove weld between the cylindrical inner edge 72 and the peripheral rib 66 on the hub 46. As shown, the edge preparation may be provided on the cylindrical inner edge 72 at the outside surface and the inside surface forming a chamfer on each side of the cylindrical inner edge 72. In some examples, a groove or grooves suitable for a full penetration weld of the web 48 to the hub 46 may be provided. Similar edge preparations may be provided at the outer cylindrical edge 70 as well. However, in some cases, fillet welds on each side of the web 48 between the outer rim 50 and the web 48 may be used and grooves might not be provided.

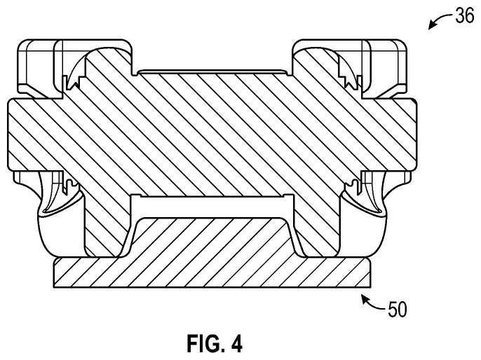

The outer rim 50 may be configured to interface with the track and, in particular, may be configured to interface with a link assembly 36 of the track to maintain the lateral position of the track and to receive radial, lateral, and tangential loads from the track. As shown in FIG. 4, for example, the link assembly 36 may include a recess on an inner (e.g., radially inner) surface for receiving a raised portion of the outer rim such that lateral motion of the link assembly 36, and thus, the track, is controlled by the idler 28. As shown in FIGS. 3A-3C, the outer rim 50 may comprise a single unitary structure. The outer rim 50 may, for example, be a generally cylindrical monolithic element free of seams. The outer rim 50 may have a cross-sectional profile defined by a generally flat inner (e.g., radially inner) surface 74 and opposing upright sides 76 extending generally perpendicular to the flat inner surface. The outer (e.g., radially outer) surface may include a central raised portion 78 flanked by two lower ledges 79A/B extending from the central raised portion 78 laterally outward to the respective upright sides 76. In one or more examples, the raised portion 78 may have a thickness approximately twice the thickness of the lower ledges 79A/B or the raised portion 78 may be 1.5, 2.5, 3, 3.5 or 4 times as thick as the lower ledges 79A/B. In still other examples, the raised portion 78 may be less than twice as thick and may, for example, be 25%, 50%, or 75% thicker than the lower ledges 79A/B. In some examples, the raised portion 78 may make up a central ½ of the width of the outer rim and the flanked lower ledges 79A/B may each make up ¼ of the width. In other examples, the raised portion 78 and the two flanked lower ledges 79A/B may each make up approximately ⅓ of the width. The overall width of the outer rim 150 relative to the web 48 may range from approximately 1.5, 2, 2.5, 3, 3.5, 4, 4.5, or 5 times the thickness of the web 48. Still other widths for the outer rim 50 may be provided. As will be discussed in more detail below, it is to be appreciate that the flanked lower ledges 79A/B of the outer rim 50 may be continuous around the circumference of the idler 28 or a segmented approach may be used.

The outer rim 50 may be arranged in direct contact with the cylindrical outer edge 70 of the web 48 and may be secured to the cylindrical outer edge 70 of the web 48 by welding, adhering, or otherwise securing the outer rim 50 to the web 48. In one or more examples, a fillet weld may be provided on each side of the web 48 to secure the web 48 to the inner surface 74 of the outer rim 50. In other examples, as mentioned, edge preparations may be provided on the cylindrical outer edge 70 of the web 48 to allow for groove welds and, in some cases, full penetration groove welds. Still other weld methods and/or connection techniques may be provided.

In one or more examples, gussets 52 may be provided to support the outer rim 50 and, in particular, the flanked lower ledges 79A/B. As shown, gussets 52 in the form of plates may be arranged along radial lines extending from the hub 46 to the outer rim 50 and the plates may be arranged perpendicular to the surface of the web 48. The gussets 52 may have an outer edge and an inner edge arranged substantially orthogonally to one another so as to engage the surface of the web 48 and the inner surface 74 of the outer rim 50. The gussets may be welded in place to support the outer rim 50 relative to the web 48. In one or more examples, 2, 3, 4 (as shown), 5, 6, 7, or 8 gussets may be provided. Still other numbers of gussets 52 may be provided. Moreover, and while not shown, in one or more examples, gussets 52 may also be provided at the transition between the web 48 and the hub 46 where the forces may be more condensed. The gussets 52 may be generally triangular elements having a nose on each of the acute angled tips. In one or more examples, while not shown, a chamfer may also be provided on the orthogonal corner to accommodate the fillet weld between the web 48 and the outer rim 50. Still other shapes for the gussets 52 may be provided.

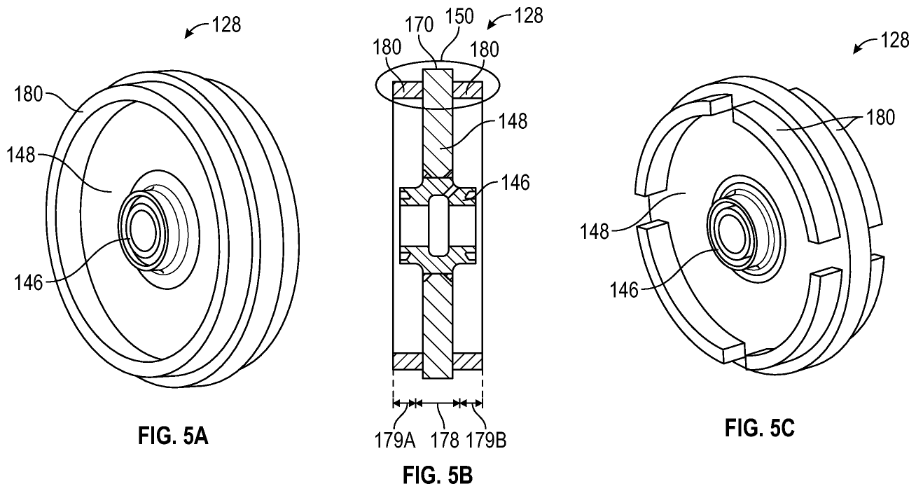

Turning now to FIGS. 5A-5C, another example of an idler 128 is shown. The idler 128 in FIGS. 5A-5C may be similar to the idler 28 of FIGS. 3A-3C. In particular, the hub 146 may be the same or similar to hub 46. Moreover, the web 148 may be the same as the web 48, except that for a similarly sized idler, the web 148 may extend further radially than the web 48 of FIGS. 3A-3C. That is, as shown, the web 148 of FIGS. 5A-5C may form a portion of the outer rim 150 by extending radially outward beyond the flanking lower ledges 179A/B. In particular, the cylindrical outer edge 170 of the web 148 may form the raised portion 178 of the outer rim 150 where the raised portion 178 of the outer rim 150 has a width substantially equal to the thickness of the web 148. The flanking lower ledges 179A/B of the outer rim 150 may be formed from separate annular rings 180 arranged on opposing surfaces of the web 148. The annular rings 180 may have an outer diameter smaller than the outer diameter of the web 148 and, as such, may form the flanking lower ledges 179A/B arranged on each side of the web 148 when viewed in cross-section as shown in FIG. 5B. The annular rings 180 may have a width that is the same or similar to the width of the web 148 such that the raised portion 178 of the outer rim 150 and the rings 180 each make up approximately ⅓ of the overall width of the outer rim 150. Still narrower or larger annular rings 180 may be provided such that the rings 180 make up, for example, ¼ of the overall width or more than ⅓ of the overall width of the outer rim 150. The annular rings may be welded in place on each side of the web 148 using fillet or groove welds. The annular rings 180 and the outer cylindrical edge 170 of the web 148 may, together, form the outer rim 150 in this example. That is, the outer rim 150 may not be a unitary structure, but, instead may include a combination of elements secured to one another including the web 148 and two annular rings 180. Nonetheless, the rings 180 may be unitary structures and may form continuous and seamless rings. However, as shown in FIG. 5C, the annular rings 180 may alternatively be segmented and might not form a full circle. In one or more examples, 4 segments may be provided or 2, 3, 5, 6, 7, 8, or other numbers of segments may be provided. In still other examples, a continuous, but seamed, annular ring 180 may be provided. While gussets are not shown in FIGS. 5A-5C, gussets may be provided to support and/or stiffen the annular rings 180 in a same or similar fashion as with the gussets of FIGS. 3A-3C.

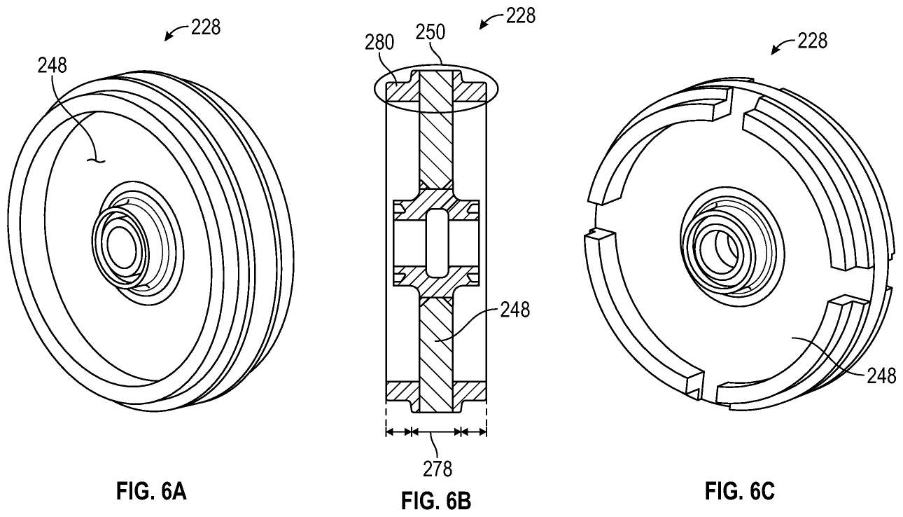

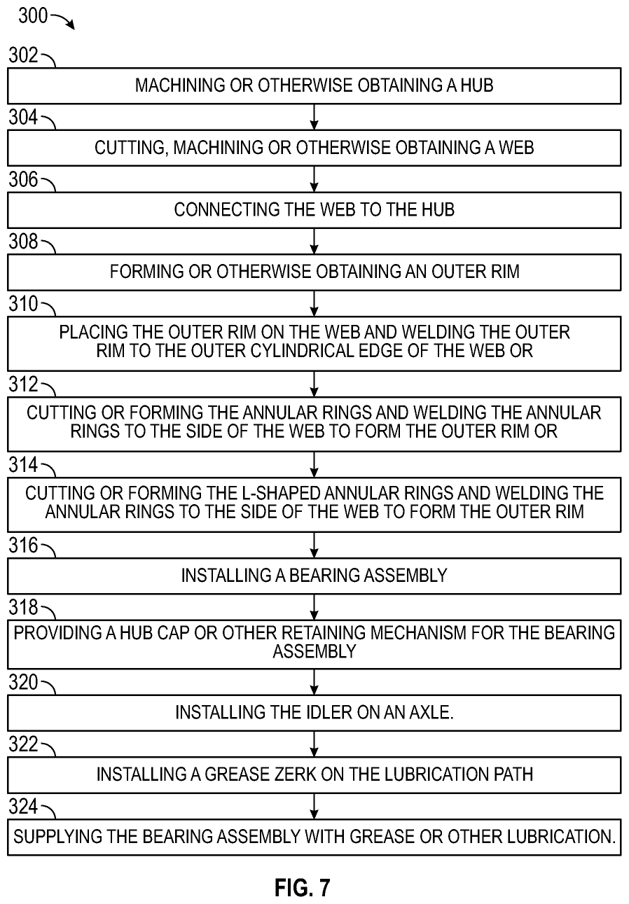

Turning now to FIGS. 6A-6C, yet another example of an idler 228 is shown. As shown, the idler 228 may be similar to the example shown in FIGS. 5A-5C, except that the cross-sectional shape of the annular rings 280 may be slightly different. As shown in FIG. 6B, for example, the annular rings 280 may have an L-shaped cross-section such that the width of the raised portion 278 of the outer rim 250 may be selected to be different than the thickness of the web 248. This may allow for a lighter or thinner web element to be used while still providing for a raised portion 278 that suitably accommodates the link assembly as shown in FIG. 4. As shown, the annular rings 280 may have a cross-sectional shape that includes a generally rectangular leg portion and an upturned lip or toe arranged alongside the web 148. The thickness of the rectangular portion (measured radially) may be the same or similar to that of the annular ring of FIGS. 5A-5C. The upturned lips or toes may have a thicknesses (measured parallel to the web thickness) selected such that, between the two of them, they make up the difference between the thickness of the web 248 and the desired width of the raised portion 278 for interacting with the link assembly. In one or more examples, the L-shaped annular rings may be welded to the web with a fillet weld along the radially inward intersection of the ring 280 and the web 248 and no weld may be provided between the web and the ring at the radially outward intersection (e.g., near the tip of the toe of the ring 280 and the cylindrical outer edge of the web 248). In other examples, a groove may be provided on the outer edge of the web 248 and/or on the outer edge of the upturned leg or lip of the ring 280 to provide for a groove weld between the ring 280 and the web 248 at that location. Grinding, machining, or other operations may be provided to create a smooth outer peripheral surface after welding, for example. Like the example of FIGS. 5A-5C, while gussets are not shown, gussets may be provided to support the annular rings relative to the web. Still further, and like the example of FIGS. 5A-5C, the L-shaped annular rings 280 may be continuous as shown in FIGS. 6A-6B and may be unitary seamless structures. Alternatively, the rings 280 may be segmented as shown in FIG. 6C and several different numbers of segments may be provided. Still further, a continuous, but seamed, annular ring 280 may also be provided.

It is to be appreciated that in some design circumstances, the design thickness of the web may be wider than the desired width of the raised portion of the idler. In these circumstances, the example idler of FIGS. 3A-3C may be provided where the width of the raised portion may be selected to be less than the thickness of the web. However, the example of FIGS. 5A-5C may also be used, where, for example, the portion of the web positioned radially outward of the flanking lower ledges is machined down to be narrower than the general thickness of the web. Still further, the example of FIGS. 6A-6C may be used where the portion of the web extending between the L-shaped annular rings is machine to be narrower allowing the L-shaped annular rings to move inward toward one another and on either side of a narrower portion of the web. Still other geometries and approaches to manufacturing the idler may also be provided.

### INDUSTRIAL APPLICABILITY

In operation and use, the presently described idler may provide for efficient manufacturing of idlers. That is, rather than having a complicated built-up weldment design, the presently described idler may be relatively straight forward and inexpensive to manufacture. That is, while potentially still constituting a weldment, the assembly and welding processes to manufacture the present idler may be relatively efficient.

A method of manufacturing an idler may include machining or otherwise obtaining 302 a hub. In the case of machining, a cylindrical blank may be obtained an an axle bore may be drilled therein or a lathe may be used to remove the material to form the axle bore. A lathe or other tool may be used to form the lubrication recess within the bore and a drill may be used to form the lubrication pathway. The outer surface of the cylindrical blank may be formed using a lathe or other tool, for example, and the hub cap groove may be similarly formed in the annular surface of the hub.

The method may also include cutting, machining, or otherwise obtaining 304 a web. In one or more examples, the web may be cut out of a plate using plasma cutting or other cutting machines or equipment.

The method may also include connecting 306 the web to the hub. As discussed above, this process may include preparing the edges of the hub and/or the web to provide for welding the two elements together. As mentioned, chamfers may be formed on one or both sides of the inner cylindrical edge of the web and/or chamfers may be formed on one or both sides of the raised peripheral rib of the hub. Connecting the web to the hub may include welding the inner cylindrical edge of the web to the raised peripheral rib of the hub by depositing weld metal in the annular groove on one or both sides of the connection of the web to the hub to form a groove weld. In other examples a butt weld may be provided. Where a peripheral rib is not provided on the hub, a fillet or groove weld may be provided.

The method may also include forming or otherwise obtaining 308 the outer rim of the idler. In one or more examples, this may include forging or otherwise forming the outer rim in the shape shown in FIGS. 3A-3C. This may also include placing 310 the outer rim on the web and welding the outer rim to the outer cylindrical edge of the web using a fillet or groove weld, for example. In the case of FIGS. SA-5C, forming the outer rim may include cutting or forming 312 the annular rings and welding the annular rings to the side of the web using a fillet or groove weld, for example. Where segmented flanking lower ledges are provided, additional welding may be provided across the ends of the segments and between segments. In the case of FIGS. 6A-6C, forming the outer rim may include cutting or forming 314 the L-shaped annular rings and welding the annular rings to the side of the web using a fillet and/or a groove weld, for example. Additional machining, grinding, or smoothing may be performed at the toe of the L-shaped annular ring where it is arranged adjacent to the outer cylindrical edge of the web. As with the segmented rings of FIG. 5C, where segmented L-shaped rings are provided as shown in FIG. 6C, additional welding may be provided across the ends of the segments.

The method may also include installing 316 a bearing assembly within the hub, providing 318 a hub cap or other retaining mechanism for the bearing assembly and/or installing 320 the idler on an axle. The method may also include installing 322 a grease zerk on the lubrication path and supplying 324 the bearing assembly with grease or other lubrication.

One or more of the welds used to assemble the idler may be performed by hand or may be performed robotically. In some examples, the circular nature of the welds may lend themselves well to use of a stationary weld stick or gun and a rotating weldment or idler. For example, the hub and the web may be arranged adjacent to one another and may be rotated about the longitudinal axis while a weld stick or gun is arranged at the seam between the two thereby welding them as the assembly rotates. A similar approach may be used to weld the outer rim or annular rings to the web. Still other jigs and welding approaches may be used.

The above detailed description is intended to be illustrative, and not restrictive. The scope of the disclosure should, therefore, be determined with references to the appended claims, along with the full scope of equivalents to which such claims are entitled.

What is claimed is:

1. An idler for a tracked machine, comprising:
a unitary hub;
a substantially unitary disk-shaped web centered on the hub and extending radially outward from the hub to an outer cylindrical edge; and
an outer rim arranged proximate the outer cylindrical edge and extending laterally relative to the disk-shaped web,
wherein, the outer rim comprises a raised portion flanked by a pair of lower ledges, the raised portion and the pair of lower ledges having a cross-sectional profile configured for engagement by a link assembly of a track system.

2. The idler of claim 1, wherein the outer rim comprises a unitary structure forming the raised portion and the pair of lower ledges.

3. The idler of claim 1, wherein the outer cylindrical edge alone forms the raised portion and annular rings are arranged radially inward from the outer cylindrical edge to form the lower ledges.

4. The idler of claim 1, wherein the outer cylindrical edge together with portions of annular rings form the raised portion and other portions of the annular rings form the lower ledges.

5. The idler of claim 4, wherein the annular rings have an L-shaped cross-section.

6. The idler of claim 1, further comprising a plurality of gussets configured to brace the lower ledges.

7. The idler of claim 6, wherein the gussets are secured to an inner or outer surface of the disk-shaped web and to a radially inward surface of the outer rim.

8. The idler of claim 7, wherein the idler comprises 4 gussets.

9. The idler of claim 1, wherein the pair of lower ledges are segmented along a circumference of the idler.

10. A track system comprising:
a drive sprocket at a first end;
the idler of claim 1 at an opposite second end; and
a track arranged to encircle the drive sprocket and the idler.

11. The track system of claim 10, further comprising a link assembly configured to guide the track along the idler.

12. A work machine comprising:
a body;
a power source;
an implement for performing work; and
the track system of claim 9.

13. A method of manufacturing an idler, comprising:
obtaining a hub;
obtaining a substantially unitary disk-shaped web;
connecting the web to the hub;
forming an outer rim by at least one of:
forming a unitary outer rim having a raised portion and flanking lower ledges, welding the outer rim to the disk-shaped web, and installing gussets; or
forming annular rings and welding the annular rings to opposing sides of the disk-shaped web to form the outer rim with a raised portion and flanking lower ledges.

14. The method of claim 13, wherein forming annular rings, comprises forming L-shaped annular rings.

15. The method of claim 14, wherein welding the annular rings to opposing sides of the disk-shaped web comprising placing a toe of the L-shaped annular ring flush with an outer cylindrical edge of the disk-shaped web and welding the L-shaped annular rings in place.

16. The method of claim 13, wherein obtaining a hub comprises machining a hub.

17. The method of claim 16, wherein machining a hub comprises forming a lubrication recess on an inside of the hub and drilling a lubrication path.

18. The method of claim 17, further comprising installing a bearing assembly in the hub.

19. The method of claim 12, further comprising installing the idler on an axle.

20. The method of claim 12, wherein obtaining a disk-shaped web comprises cutting the disk-shaped web out of flat plate.
